(19) United States
(12) Patent Application Publication
(10) Pub. No.: US 2005/0189016 A1
(43) Pub. Date: Sep. 1, 2005

(54) Recirculation system

(76) Inventors: James E. Bell JR., Linwood, KS (US); Robert James Bell, Tonganoxie, KS (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/068,172

(22) Filed: Feb. 28, 2005

Related U.S. Application Data
(60) Provisional application No. 60/549,066, filed on Mar. 1, 2004.

(51) Int. Cl. F17D 3/00

(52) U.S. Cl. 137/2; 137/12; 137/560

(57) ABSTRACT

A system for receiving effluent from an apparatus, for example, a sterilizer, sterilizer unit or sterilizer system, or other device(s), that initially determines the temperature of the effluent. If the effluent temperature is such that the effluent is “hot”, the effluent it is not suitable for reuse, and the effluent is sent to be tempered, such that it cold enough to be released into a drain, whereby it will not damage the drain. If the effluent temperature is such that the effluent is “cold”, the effluent is suitable for reuse and therefore, will be recirculated to the device. The effluent moves into a holding tank, where it combines with water, and is pumped to the apparatus.

### CROSS-REFERENCES TO RELATED APPLICATIONS

This application is related to and claims priority from commonly owned U.S. Provisional Patent Application Ser. No. 60/549,066, entitled: Recirculation System, filed on Mar. 1, 2004. U.S. Provisional Patent Application Ser. No. 60/549,066 is incorporated by reference herein.

### TECHNICAL FIELD

The present invention is directed to a system that routes effluent, fluid including water, steam, steam condensate, or combinations thereof, released from apparatus, such as, sterilizers, sterilizer units, sterilizer systems or other devices. In particular, the present invention is directed to a system that recirculates effluent, released from an apparatus, such as a sterilizer, sterilizer unit or sterilizer system or other water using device(s), to the apparatus, when the apparatus needs fluid (water).

### BACKGROUND

Steam sterilizers are commonly used in hospitals, universities and other institutional facilities to sterilize equipment. An exemplary sterilizer unit 20, as shown in FIG. 1, in large broken lines, is formed of a sterilizer 22, that includes a sterilization chamber 24, into which the components 25, for example, instruments, tools, and the like, are put or placed for sterilization. An outer jacket 26 surrounds the chamber 24, for warming and insulating it.

Steam is introduced into the jacket 26, to insulate and heat the chamber 24, and separately into the chamber 24, to sterilize the components 25. The steam from the jacket 26 and the chamber 24 is typically collected in steam traps 30, over lines 31a, 31b. The collapsed or trapped steam, then travels over lines 35a, 35b, respectively, where it combines with municipal or city water, that is continuously delivered over a line 36 (at rates of 0.5 to 5 gallons per minute, depending on the particular sterilizer), when the valves (V1) 37, typically needle valves, are opened. The mixing of the steam and/or steam condensate with the city water normally tempers the water to a temperature typically less than 140° Fahrenheit (60° Celsius), to be in accordance with building codes. This is because water at over 140° Fahrenheit (60° Celsius) damages pipes and causes of leaching of heavy metals therein, whereby they are released into the water flowing through the pipes and ultimately, into the outside environment.

The mixed water and steam (or steam condensate), tempered to less than 140° Fahrenheit (60° Celsius) moves through a common line 38, and exits through the common line 38. While the steam has been tempered, the process of doing so wastes large amounts of water.

A chamber drain line 39 extends from the chamber 24 of the sterilizer 22, and, as shown in FIG. 2, connects to an ejector 40. The chamber drain line 39 and ejector 40, are typically coupled with sterilizer unit 20, defining an apparatus, for example, a sterilizer system 20′ (shown in large broken lines). The ejector 40 is also connected to an inflow line 42 (similar to line 36, and as shown is a branch line from line 36), through which it constantly receives municipal or “city” water (municipal and city water are used interchangeably in this document), for example, at 5-15 gallons per minute (gpm). The ejector 40 uses the city water to create a venturi effect, to create or pull a vacuum in the chamber 24 of the sterilizer 22, through the chamber drain line 39. The ejector 40 pulls all of the air (as well as any water, steam, steam condensate, etc., that may remain in the chamber 24, the line 39, or both) out of the chamber 24, to maximize sterilization.

The water used to pull the vacuum in the sterilizer 22, as well as the steam from the chamber drain line 39, is then sent out through a drain line 44, where it is released to the municipal drainage, sewer or other drainage system, indicated as WASTE, for passage to the outside environment. This process results in large amounts of water being wasted. Moreover, when coupled with the wasted water involved with steam and condensate tempering, these contemporary systems are not environmentally friendly.

### SUMMARY

The present invention provides a system that determines if effluent, fluid that includes water, steam, steam condensate, or combinations thereof, is suitable for reuse based on its temperature. If the effluent is “hot”, it is not suitable for reuse, and is tempered, such that it is sufficiently cooled to be released into a drain, whereby it will not damage the drain. If the effluent is “cold”, this effluent is suitable for reuse and therefore, will be recirculated. The recirculated water is then sent back to the requisite apparatus, such as a device, unit or system.

For example, when used with an apparatus, such as a sterilizer system, the recirculation system of the invention is such that captured water is reused, as it is recirculated from a holding tank or other collection vessel to the requisite sterilizer system. The reused water, stored in the tank, coupled with its recirculation to the sterilizer system, and, for example, to the ejector, at pressures sufficient for the ejector to pull the necessary vacuum in the sterilizer, eliminates the need to continuously deliver city water to the ejector. As a result, the ejector does not need, and therefore, does not have a direct supply line for city water, for pulling the vacuum, as water supplied through recirculation at the requisite vacuum pulling pressures, is sufficient for this purpose.

Accordingly, the invention is environmentally friendly as it conserves water. For example, in the case of large water consuming devices, such as steam sterilizers and the like, recirculation of the water for its subsequent reuse will result in significant savings on water costs associated therewith.

An embodiment of the invention is directed to an effluent management system. The system includes, a system that controls the flow of the effluent based on the temperature of the effluent being suitable to be reused; a system for recirculating the effluent that is of a temperature suitable to be reused, to an apparatus; and, a steam collapsing system coupled to the flow controlling apparatus, the steam collapsing system for receiving effluent of a temperature not suitable to be reused. The effluent management system is typically employed with an apparatus that releases effluent and uses fluid, typically water, the apparatus being, for example, sterilizers, sterilizer units, sterilizer systems or other water using devices.

Another embodiment of the invention is directed to a recirculation system, for example, for fluid, such as effluent released from an apparatus, for example, sterilizers, sterilizer units, sterilizer systems or other water using devices. The recirculation system includes, a fluid holding vessel; a system for directing the fluid received into the system to the fluid holding vessel, if the fluid is at least at a predetermined temperature; a pump coupled to the fluid holding vessel; and, a line coupled to the pump, through which fluid is delivered to an apparatus.

Another embodiment of the invention is directed to a method for managing effluent. The method includes, determining if the effluent is suitable for reuse, based on its temperature; causing the effluent to flow to a recirculation system if the temperature is such that the effluent is suitable for reuse; and, causing the effluent to be tempered such that it is suitably cool to be released into a drain, if the temperature of the effluent is such that it is not suitable for reuse.

Another embodiment of the invention is directed to a method for recirculating fluid released from an apparatus, the apparatus being, for example, a sterilizer, sterilizer unit, sterilizer system or other water using other device(s). The method includes, providing a recirculation system including, a holding tank for fluid, a pump coupled to the holding tank, and, a conduit or line coupled to the pump and for being coupled to the apparatus. The fluid released from the apparatus is directed to a holding tank, if the fluid is at least at a predetermined temperature. A pump is then activated, typically in response to a pressure change in the conduit or line coupled to the pump, to deliver fluid from the holding tank to the apparatus.

### BRIEF DESCRIPTION OF THE DRAWINGS

Attention is now directed to the drawing figures, where corresponding or like numerals and/or characters, indicate corresponding or like components. In the drawings:

FIG. 1 is diagram of a sterilizer system in accordance with the contemporary art;

FIG. 2 is diagram of another aspect of the sterilizer system of FIG. 1;

FIG. 3 is a schematic diagram of a recirculation system in accordance with an embodiment of the invention in an exemplary set up, with the valve switch in an open position;

FIG. 4 is a schematic diagram of a recirculation system in accordance with an embodiment of the invention in an exemplary set up, with the valve switch in a closed position; and,

FIGS. 5 and 6 are perspective views of the recirculation system, shown schematically in FIGS. 3 and 4, in accordance with an embodiment of the invention.

### DETAILED DESCRIPTION OF THE DRAWINGS

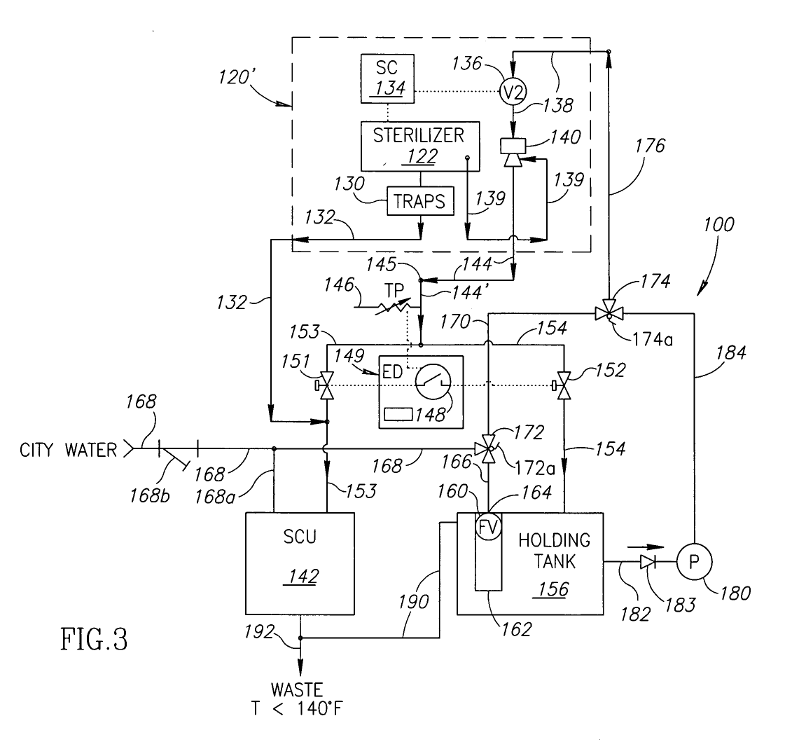

FIG. 3 shows a schematic diagram of the recirculation system 100 of the invention. The recirculation system 100 is shown in an exemplary set up and operation. In this exemplary set up and operation, the recirculation system 100 is shown in use with an apparatus, for example, a sterilizer system 120′ (shown in large broken lines), that is typically modified for use with the recirculation system 100.

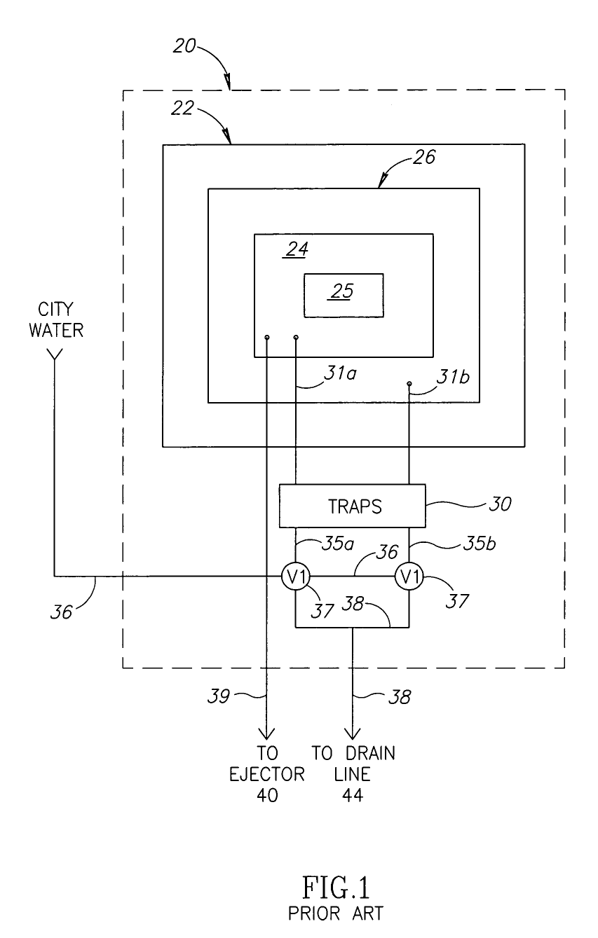

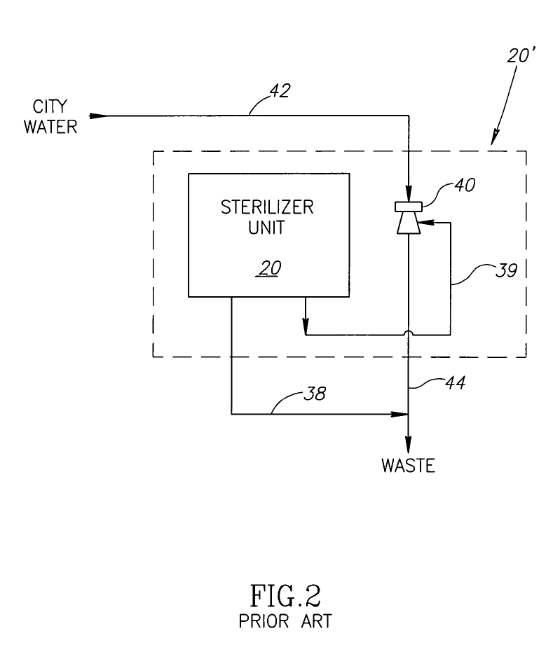

The sterilizer system 120′ includes a sterilizer 122 (similar to the sterilizer 22 detailed above and shown in FIGS. 1 and 2) with steam traps 130 (similar to the steam traps 30 detailed above and shown in FIGS. 1 and 2). The sterilizer 122 is coupled to the steam traps 130, similar to the sterilizer 22 and steam traps 30, detailed above and shown in FIGS. 1 and 2. A drain line 132 extends from the steam traps 130, exits the sterilizer system 120′, and connects to the recirculation system 100 at the line 153, for passing water to the steam collapsing unit (SCU) 142 (detailed below). The connection to the line 153 is typically downstream of the valve 151.

A sterilizer controller (SC) 134 (or sterilizer control unit) is electrically connected to the sterilizer 122 and a valve (V2) 136, for example, a solenoid valve. A feed line 138, extending from the edge of the sterilizer system 120′ (to receive the recirculation line 176, detailed below) to an ejector 140, is controlled by the valve (V2) 136 along the feed line 138. A chamber drain line 139 (similar to the chamber drain line 39 detailed above) connects to the ejector 140. The ejector 140 is similar to the ejector 40 detailed above, as pulls a vacuum in the chamber (not shown) of sterilizer 122, through the chamber drain line 139, by using with flowing water.

A steam collapsing unit (SCU) 142 (also serving as a fluid tempering unit) is also located along the recirculation system 100, to temper water that is too hot, typically greater than 140° Fahrenheit, typically for release to the outside environment. This steam collapsing unit (SCU) 142 is, for example, the unit disclosed in commonly owned U.S. patent application Ser. No. 10/374,127 (U.S. patent application Publication 2004/0166020, entitled: Steam Collapsing Apparatus and System, published Aug. 26, 2004), this patent application incorporated by reference herein, and which is commercially available as the WATER-MIZER™ from Continental Equipment Company, Lawrence, Kans. 66044.

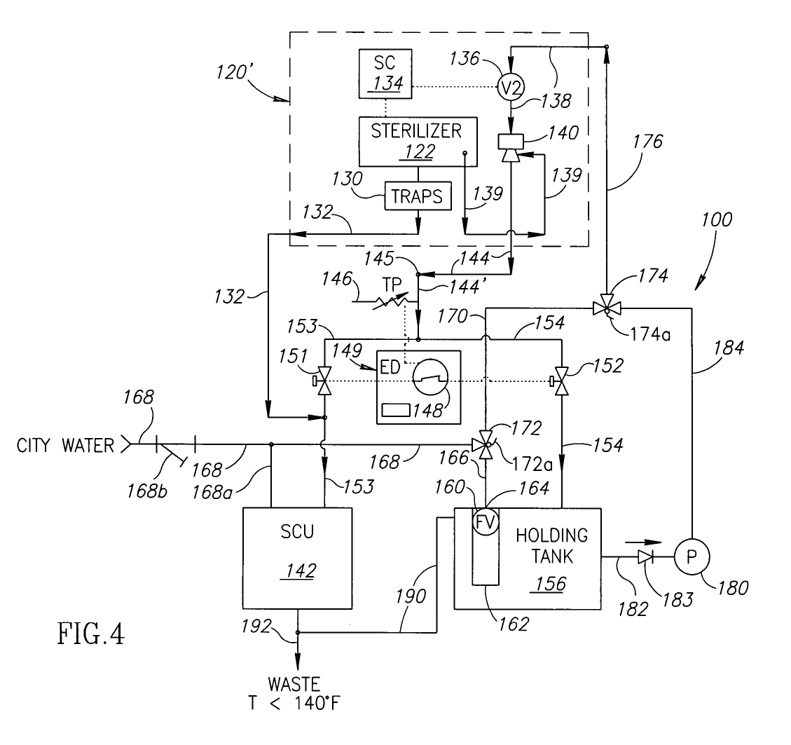

In FIG. 3 and also in FIG. 4, electrical connections are shown in short broken lines. These electrical connections are typically wired links, but could also be wireless links or combinations of wired and wireless links. While the significant electrical connections are shown, other components are typically electrically connected to each other. Additionally, in FIGS. 3 and 4, typical fluid flow paths, illustrative of normal operation of the system 100 and the exemplary set up, are indicated by arrowheads and arrows.

The system 100 includes an intake line 144′ that is continuous with a drain line 144 (similar to line 44 detailed above), extending from the ejector 140. The intake line 144′ receives effluent, for example, fluid, such as water, steam, steam condensate or combinations thereof, through an inlet or opening 145, as discharged from a drain line 144 at the ejector 140.

A temperature probe (TP) 146 (typically controlled by a processor-based logic controller or other computer-type device, or the like, associated therewith) monitors the temperature of the effluent flowing through the intake line 144′. This temperature probe (TP) 146 is electrically linked (either directly or through the processor-based logic controller associated therewith), by wired or wireless links, or combinations thereof (shown in short broken lines), to a switch 148, that is automatic, and moves between open (FIG. 3) and closed (FIG. 4) positions. The temperature probe 146 is typically programmable to threshold temperatures, so as to signal the switch 148, when the effluent flow has moved above or below the threshold temperature for alternately, based upon the programming of the logic controller, has moved up to at least the threshold temperature, or has moved down to at least the threshold temperature), in order to move the switch 148. The switch 148 is typically housed in an entry device (ED) 149.

The threshold temperature for the temperature probe 146 can be entered by an operator into the entry device (ED) 149, that is electrically linked to the temperature probe (TP) 146. For example, when used with a conventional sterilizer, sterilizer unit or sterilizer system, the threshold temperature is typically set to approximately 70° to approximately 95° Fahrenheit, although temperatures up to approximately 140° Fahrenheit are also considered to be acceptable, as they are within building codes (as detailed above).

The switch 148 is electrically linked to valves 151, 152, typically solenoid valves. These valves 151, 152 are positioned along flow lines 153, 154, and control the flow through these lines 153, 154. The lines 153, 154 define pathways to the steam collapsing unit (SCU) 142 and a water holding tank 156, respectively.

For example, the switch 148 is normally open (as shown in FIG. 3), such that in a typical operation, when the switch is in the OPEN position, the valve 151 controlling the flow path to the steam collapsing unit (SCU) 142 is normally open, while the valve 152, controlling the path to the holding tank 156 is normally closed. However, should the temperature probe (TP) 146 detect effluent below the threshold temperature, the switch 148 will move to the CLOSED position (as shown n FIG. 4), whereby the valve 151 controlling the flow path to the steam collapsing unit (SCU) 142 closes, and the valve 152, controlling the path to the holding tank 156 opens.

The water holding tank 156 is a vessel, container, or the like for holding fluid (water) sufficient for one or more recirculation cycles. The tank 156 includes a float valve (FV) 160, that rides in a column 162. When the water level in the holding tank 156 has risen to a sufficient level, the float valve (FV) 160 closes off an opening 164 to a sub-line 166, that is joined to an inflow line 168 for municipal or city water, and a bypass line 170, at a valve 172. The inflow line 168 includes a branch line 168a, through which city water is supplied to the steam collapsing unit (SCU) 142, and a strainer 168b, to remove mineral deposits and the like, from the inflowing city water.

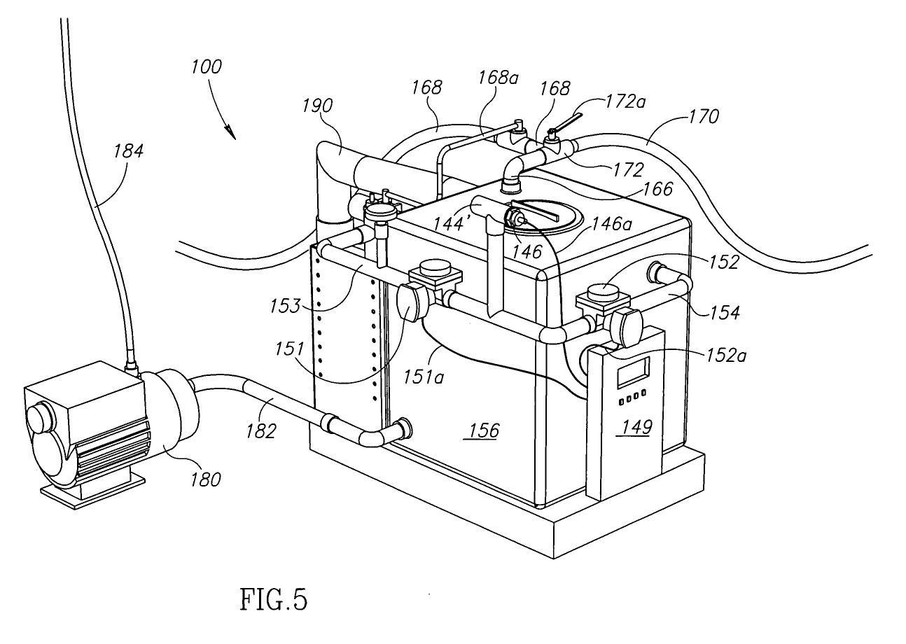

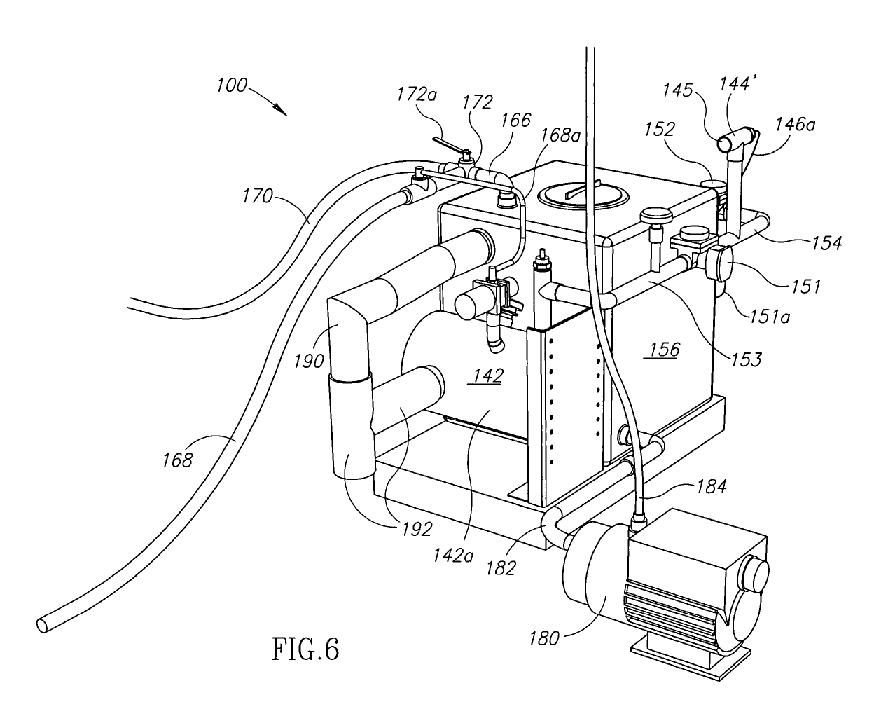

The valve 172 is, for example, a three way ball valve, that is manually set by an operator, typically by turning a handle 172a (shown in detail in FIGS. 5 and 6). The typical position of this valve 172 is such that city water normally flows from outside the system 100 (indicated as CITY WATER), through the inflow line 168 and the sub-line 166, into the holding tank 156. The valve 172 may also be automatic.

The bypass line 170 terminates in a valve 174, that is also, for example, a three-way manually set ball valve (set the user turning a handle 174a), similar to valve 172 (detailed immediately above). In its typical and normal operating position, the valve 174 is closed off to fluid flow from the bypass line 170, and is open to fluid flow through the outflow line 184.

A recirculation line 176 extends from the valve 174 to the feed line 138, and attaches to the feed line 138. The recirculation line 176 supplies water to the ejector 140, through the feed line 138, when the valve (V2) 136 is open (in an open position). The water passing through the recirculation line 176 and the feed line 138 is at pressures sufficient for the ejector 140 to pull the vacuum necessary to maximize sterilization in the sterilizer 122, as detailed above. The valve (V2) 136 is normally closed (in a closed position) prohibiting water from flowing through the feed line 138. The valve (V2) 136 opens when it receives a signal from the sterilizer controller (SC) 134, that typically controls the valve (V2) 136 opening in accordance with a predetermined program, for fluid (water) delivery to the sterilizer system 120′.

The water holding tank 156 is coupled to a pump (P) 180 along a line 182. A one way valve 183 is also along the line 182 and serves to prevent fluid from flowing back into the holding tank 156. The pump (P) 180 provides a pumping force sufficient to recirculate the fluid (water), stored in the holding tank 156 back to ejector 140 (or other applicable component, apparatus or the like), through the outflow line 184, the valve 174 (in its normal position), the recirculation line 176, the valve (V2) 136 (in its open position), and the feed line 138. The pump (P) 180 is, for example, a Grundfos Pump Model MQ3-45.

The pump (P) 180 typically includes a pressure sensor, detector or the like (not shown) and control logic, typically processor based (not shown), associated therewith. This pressure sensor is such that it can be programmed (either at the factory or by a user) to detect a threshold pressure in the outflow line 184. When the pressure in the outflow line 184 falls below the threshold pressure (or alternately, depending upon the programming of the control logic, when the pressure falls to at least the threshold pressure), the pump (P) 180 is activated. The pressure drop in the outflow line 184 is caused by the sterilizer controller (SC) 134, opening the valve (V2) 136, releasing the water pressure in the lines 184, 176, 138, as the water therein moves into the ejector 140 (the pump (P) 180, while inactive, serving as a closed valve for the line 184).

The now activated pump (P) 180 recirculates fluid (water) from the holding tank 156, through the outflow line 184, through the recirculation line 176 and through the feed line 138 (at least the outflow 184 and recirculation 176 lines forming a fluid supply line for the system 100), to the ejector 140. Once the sterilizer controller (SC) 134 has allowed an amount of water into the ejector 140, as typically preprogrammed therein (for example, this predetermined amount of water sufficient for at least one recirculation cycle), the valve (V2) 136 is closed, as signaled by the sterilizer controller (SC) 134. The closing of the valve (V2) 136 causes the water pressure in the outflow line 184 to increase and return to a pressure above the preset threshold pressure (or alternately, depending upon the programming of the control logic, when the pressure rises to at least the threshold pressure), whereby the pump (P) 180 deactivates (shuts off).

Should the pump (P) 180 become non functional, there is a bypass. In this case, the valves 172 and 174 would be manually set, such that there is a flow path for city water from the inflow line 168, through the bypass line 170, through the recirculation line 176, and to the feed line 138. The sub-line 166 and the outflow line 184 would be closed off by the respective valves 172, 174. As the valve (V2) 136 is under the control of the sterilizer controller (SC) 134, a circulation of city water to the ejector 140 would occur when the sterilizer controller (SC) 134 opens the valve (V2) 136, in accordance with its program(s). The municipal water pressure is sufficient to drive the water along this path of lines 168, 170, 176 and 138, and to pull the vacuum in the ejector 140.

An overflow line 190 extends from the water holding tank 156 and goes to the drain line 192, that is also the drain line for the steam collapsing unit (SCU) 142. The overflow line 190 connects to the tank 156 at its upper end. Overflow conditions, where fluid exits through the overflow line 190, may occur, when the tank 156 is full (the float valve (FV) 160 is at its highest elevation in the column 162 blocking the opening 164 of the tank 156) and there is not any pumping by the pump (P) 180 to relieve the tank 156 of water. Through the drain line 192, water flows into a municipal waste or sewer system or the like of the outside environment (indicated in FIGS. 3 and 4 as WASTE).

Turning also to FIG. 5, there is shown a perspective view of the recirculation system 100, in particular, illustrating the holding tank 156. All components shown in the schematic diagrams of FIGS. 3 and 4 are numbered identically in this drawing figure. Additions are noted here.

The holding tank 156 is typically a square or rectangular cube and, for example, has a capacity of approximately seven gallons. Electrical lines 146a, 151a and 152a (corresponding to the broken lines of FIGS. 3 and 4) extend from the switch (not shown) in the entry device (ED) 149 to the temperature probe (TP) 146, and valves 151, 152, respectively. The three way valve 172 includes the manually moveable handle 172a (also on FIGS. 3 and 4). A similar manually moveable handle 174a (FIGS. 3 and 4), is also present on the three way valve 174 (FIGS. 3 and 4).

Turning also to FIG. 6, this drawing figure is similar to FIG. 5 (and components are numbered identically), but shows a perspective view based on the steam collapsing unit (SCU) 142. The steam collapsing unit 142 includes a body 142a, that provides it with its cylindrical shape.

Turning back to FIGS. 3 and 4, exemplary operations of the system 100 are detailed. In FIG. 3, the switch 148 is in its normal or open position, such that the valve 151 is open (valve 152 is closed), and accordingly, the effluent from the drain line 144 is “hot”, as determined by the temperature probe (TP) 146. In FIG. 4, the switch 148 is in its closed position, such that the valve 152 is open (and the valve 151 is closed), and accordingly, the effluent from the drain line 144 is “cold”, as determined by the temperature probe (TP) 146.

In FIG. 3, the “hot” effluent in line 144′ flows through the line 153 to the steam collapsing unit (SCU) 142. In the steam collapsing unit (SCU) 142, the effluent is tempered, as described in U.S. patent application Ser. No. 10/374,127 (U.S. patent application Publication 2004/0166020), for its safe release to the outside environment, through the drain line 192.

In FIG. 4, the “cold” effluent in line 144′ flows through the line 154 to the holding tank 156. The effluent fills the tank 156 and it may also be filled by city water, from the inflow line 168, through the sub-line 166. When the pump (P) 180 senses a pressure drop, below a threshold pressure, in the outflow line 184, caused by the valve (V2) being opened (and the water in the line 184 moves out of the line 184 toward the ejector 140), as controlled by the sterilizer controller (SC) 134, the pump (P) 180 activates. The pumped fluid (water) leaves the tank 156 and is delivered or recirculated to the ejector 140 at pressures sufficient to pull a vacuum in the sterilizer 122.

Alternately, should the tank 156 fill and the pump (P) 180 fail to operate, excess water will exit the tank 156 through the overflow line 190.

Should a the pump (P) 180 be inoperative, a bypass of the pump, whereby city water is delivered to the ejector 140, at pressures sufficient for the ejector to pull the requisite vacuum in the sterilizer 122 (as detailed above), may be performed manually. In this bypass, valves 172 and 174 are opened, to create a pathway from the inflow line 168, through the bypass line 170, through the recirculation line 176, and through the feed line 138, to the ejector 140. The valve (V2) 136 along the feed line 138 is opened (and closed) by the sterilizer controller (SC) 134 in accordance with its program(s).

While preferred embodiments of a recirculation system and methods for its use have been shown and described above, so as to enable one of skill in the art to practice the present invention, the preceding description is intended to be exemplary only. It should not be used to limit the scope of the invention, which should be determined by reference to the following claims.

1. An effluent management system comprising:
a system configured for controlling the flow of the effluent based on the temperature of the effluent being suitable for the effluent to be reused;
a system for recirculating the effluent that is of a temperature suitable to be reused, to an apparatus; and
a steam collapsing system in communication with the flow controlling apparatus, the steam collapsing system configured for receiving effluent of a temperature not suitable to be reused.

2. The system of claim 1, wherein the flow controlling system includes:
at least one first conduit defining a pathway for the effluent to flow from an inlet to the recirculaton system;
at least one second conduit defining a pathway to the steam collapsing unit; a temperature detector; and
flow controllers moveable between open and closed positions, in each of the at least one first conduit and the at least one second conduit, each of the flow controllers in electrical communication with the temperature detector, such that in accordance with the temperature detected by the temperature detector, one of the flow controllers will be in the open position, and one of the flow controllers will be in the closed position.

3. The system of claim 2, wherein the flow controllers include valves.

4. The system of claim 3, wherein the valves are automatic.

5. The system of claim 1, wherein the recirculation system includes a pump.

6. The system of claim 5, wherein the recirculation system includes a vessel for holding fluid in communication with the pump.

7. The system of claim 6, wherein recirculation system additionally comprises: a fluid supply line in communication with the pump and configured for communication with an apparatus.

8. The system of claim 7, wherein the pump is configured to activate upon the detection of a pressure drop to at least a predetermined pressure in at least a portion of the fluid supply line and to deactivate upon the detection of a pressure increase to at least the predetermined pressure.

9. The system of claim 8, wherein the pump includes a pressure sensor.

10. The system of claim 1, wherein the steam collapsing system includes a fluid tempering unit.

11. A recirculation system comprising:
a fluid holding vessel;
a system for directing the fluid received into the system to the fluid holding vessel, if the fluid is at least at a predetermined temperature;
a pump in communication with the fluid holding vessel; and
a conduit in communication with the pump and configured for communication with an apparatus.

12. The system of claim 11, wherein the pump is configured to activate upon the detection of a pressure drop to at least a predetermined pressure in at least a portion of the fluid supply line and to deactivate upon the detection of a pressure increase to at least the predetermined pressure.

13. The system of claim 12, wherein the pump includes a pressure sensor.

14. The system of claim 11, wherein the fluid directing system includes,
at least one pathway for fluid to flow into the fluid holding vessel;
at least one pathway for fluid to flow into a fluid tempering unit;
at least one flow control device along the at least one pathway for fluid flow into the fluid holding vessel, the at least one flow control device moveable between open and closed positions in accordance with the temperature of the fluid.

15. The system of claim 14, wherein the at least one flow control device includes two flow control devices, one of the flow control devices along the at least one pathway for fluid flow into the fluid holding vessel, and one of the flow control devices along the at least one pathway for fluid flow into a fluid tempering unit.

16. The system of claim 15, wherein the fluid directing system additionally includes, a temperature detector in electrical communication with each of the flow control devices, such that in accordance with the temperature detected by the temperature detector, one of the flow control devices will be in the open position, and one of the flow devices will be in the closed position.

17. The system of claim 16, wherein the temperature detector includes a temperature probe.

18. The system of claim 16, wherein the flow control devices include valves.

19. The system of claim 11, wherein the predetermined temperature is approximately 70° Fahrenheit to approximately 95° Fahrenheit.

20. The system of claim 15, additionally comprising: a fluid tempering unit.

21. A method for managing effluent comprising:
determining if the effluent is suitable for reuse based on the temperature of the effluent;
causing the effluent to flow to a recirculation system if the temperature is such that the effluent is suitable for reuse; and
causing the effluent to be tempered such that it is suitably cool to be released into a drain, if the temperature of the effluent is such that it is not suitable for reuse.

22. The method of claim 21, wherein determining if the effluent is suitable for reuse includes obtaining the temperature of the effluent.

23. The method of claim 21, additionally comprising recirculating the effluent to an apparatus once the effluent has been received in the recirculation system.

24. The method of claim 23, wherein the recirculation is activated upon the detection of a pressure drop to at least a threshold pressure in the recirculation system.

25. A method for recirculating fluid released from an apparatus comprising:
providing a recirculation system including:
a holding tank for fluid;
a pump in communication with the holding tank; and
a conduit in communication with the pump and configured for communication with the apparatus, for providing fluid to the apparatus;
directing the fluid released from the apparatus to the holding tank if the fluid is at least at a predetermined temperature; and
activating the pump to deliver fluid from the holding tank to the apparatus.

26. The method of claim 25, additionally comprising: deactivating the pump when a predetermined amount of fluid has been delivered to the apparatus.

27. The method of claim 25, additionally comprising: directing the fluid released from the apparatus to a fluid tempering unit if the fluid is not at least at the predetermined temperature.

28. The method of claim 27, additionally comprising, measuring the temperature of the fluid released from the apparatus.

29. The method of claim 28, wherein the predetermined temperature is approximately 70° Fahrenheit to approximately 95° Fahrenheit.

30. The method of claim 25, wherein activating the pump includes detecting a pressure drop to at least a predetermined pressure in at least a portion of the conduit.

31. The method of claim 26, wherein deactivating the pump includes detecting a pressure increase to at least a predetermined pressure in at least a portion of the conduit.
